(19) United States
(12) Patent Application Publication
(10) Pub. No.: US 2025/0326543 A1
(43) Pub. Date: Oct. 23, 2025

(54) Keyless Battery Powered Locking Container Cap Cover

(71) Applicants: Robert Joseph Ponticelli, SR., Green Valley, AZ (US); Robert Joseph Ponticelli, JR., Green Valley, AZ (US)

(72) Inventors: Robert Joseph Ponticelli, SR., Green Valley, AZ (US); Robert Joseph Ponticelli, JR., Green Valley, AZ (US)

(21) Appl. No.: 17/803,198

(22) Filed: Nov. 10, 2023

Related U.S. Application Data
(60) Provisional application No. 63/475,512, filed on Nov. 14, 2022.

(51) Int. Cl. B65D 55/10; B65D 53/02; B65D 81/02; E05B 47/00; E05B 65/00

(52) U.S. Cl. CPC B65D 55/10; B65D 53/02; B65D 65/44; E05B 47/0012; E05B 65/00; B65D 2203/10; B65D 2255/06; B65D 2313/04; E05B 2047/0017; E05B 2047/0024; E05B 2047/0058; E05B 2047/0065

(57) ABSTRACT

A keyless battery powered locking container cap cover comprising hinged left and right elements configured with a lid and bottom shelfs remaining unlocked after being closed and latched around a container cap then freely rotating around said cap where power is turned off saving energy while further configured with a dual locking mechanism comprising a flat metal latching spring positioned in front of a hidden locking switch where depressing an unlatching button instantly activates a motorized offset cam to drive a secondary pin loaded locking spring into a locked position whereby the hinged left and hinged right elements will be pinned together locking the invention where activating a remote transmitter that sends a bypass signal to a lock switch on the invention before depressing the latch release button prevents the locking function; if not the secondary pin loaded locking spring will instantly lock the invention; no DOT approval.

### BACKGROUND OF THE INVENTION

The inventors and owners Robert Joseph Ponticelli Sr. and Robert Joseph Ponticelli Jr. of provisional patent application No. 63/475 512 filed Nov. 14, 2022 for a KEYLESS BATTERY POWERED LOCKING CONTAINER CAP COVER as an accessory in the field of Classification 65D 55/10 and B65D 53/02; further, the owners of U.S. Pat. No. 10,940,984 B2, Robert Joseph Ponticelli Sr. and Robert Joseph Ponticelli Jr. hereby claim the benefit of US provisional patent application No. 63/475 512 dated Nov. 14, 2022 including all the following as an improvement patent over U.S. Pat. No. 10,940,984 thereof.

### INTRODUCTION/BRIEF SUMMARY OF THE INVENTION

U.S. Pat. No. 10,940,984 was designed as a BATTERY POWERED KEYLESS LOCKING CAP. However, it was later learned that in order to market the product it must first pass Department of Transportation testing. To pass this testing process is not only very expensive but can take a very long time to do so. Therefore; the decision was made to improve the invention while making the invention in such a way as to not need Department of Transportation certification. Almost two years later a new model was designed that was not a locking container cap as stated in U.S. Pat. No. 10,940,984 B2 but instead designed as a KEYLESS BATTERY POWERED LOCKING CONTAINER CAP COVER configured to encapsulate and lock over and around an existing container cap comprising some of the features of U.S. Pat. No. 10,940,984; while greatly improving U.S. Pat. No. 10,940,984 many improvement revisions were discovered. The revised design is much safer, cost less to produce and superior in many ways and falls into the same class as U.S. Pat. No. 10,940,984: CPC, B 65D 55/10 and B 65D 53/02 as listed in U.S. Pat. No. 10,940,984 as a container accessory. It was then decided that an improvement patent was in order. The many improvements are described below:

The battery powered keyless locking cap of U.S. Pat. No. 10,940,984 b2 has been re-configured and improved as a rechargeable battery powered keyless locking hinged container cap cover that fully encapsulates an existing container cap subsequent to attachment where:
1. the hinged container cap cover will frictionally rotate around the existing container cap after attachment;
2. the battery or batteries have been relocated within the lid of the keyless locking container cap cover;
3. the battery or batteries are thermally insulated and protected by fire rated Styrofoam panels or the equivalent;
4. The lid is captured by female channels in the hinged left and hinged right elements;
5. an o ring within a channel around the lid allows for a water tight seal;
6. the electronics have been relocated out of the container filler tube away from fumes or liquids into a separate electronics housing;
7. the separate electronics housing is positioned in an area attached to the front of the hinged left and hinged right elements;
8. an additional lock latching method has been incorporated into the design providing a much higher security measure; when closed, a flat metal latching spring latches the hinged right element to the hinged left element;
9. where the flat metal latching spring cannot be unlatched without first triggering a secondary locking spring loaded locking pin that locks the hinged right element to the hinged left element;
10. an unlatching button must be depressed to unlatch the latching spring; where a hidden locking switch adjacent to the flat metal latching spring instantly triggers the electronics program to lock the device in less than one second;
11. a secondary compression spring further delays the un-latching function; where custom adaptors allow only one base model to provide a custom rattle free fit to most container caps;
12. a Department of Transportation certification is not required for use;
13. opposing magnets serve as a spring to open and separate the hinged left and hinged right elements when unlocked;
14. the pin coded unlocking function has been relocated to a more convenient area on the top of the electronics housing;
15. the elements to enter the pin code unlocking method were re-configured as easier to use momentary switches; where a rechargeable feature was added and
16. an LED was added to indicate low battery, locked or unlocked and correct pin code entry;
17. Overlapping seam covers were added to prevent pry apart the hinged right element from the hinged left element.

### BRIEF DESCRIPTION OF THE DRAWINGS

FIG. 01 is a perspective view of a keyless battery powered locking container cap cover 100.

FIG. 02 is a cutaway drawing depicting cap 50, filler tube 50a and container top 50b where right element 6 partially surrounds cap 50; 6g is an LED; 8a is an element of hinge pin 8; 11a is button mounting hole for button 11; 12j is a cylinder a magnet; 2y is a seam covering bezel.

FIG. 03 is a perspective view of RF transmitter 200 configured as a cigarette lighter plug constructed in accordance with the teachings of the present invention.

FIG. 04 is an exploded view of an RF Transmitter where 301 is the transmitter switch; 302 is the threaded portion that goes through a dash panel; 303 is the nut; 304 is a connector; 305 receives connector 304 and 306 are hookup wires constructed in accordance with the teachings of the present invention.

FIG. 05 comprises the first page of a two-page exploded view of the elements of a battery powered keyless locking container cap cover 100 of FIG. 01 as depicted within bracket 120 of FIG. 05.

FIG. 05A comprises the second page elements of a battery powered locking container cap cover within bracket 125.

FIG. 06 depicts a block diagram of receiver circuit.

FIG. 07 depicts diagrams of the transmitter circuit.

FIG. 08 is a side view of lid 1 depicting seam hiding groove 2a and ledge 2.

FIG. 08A is a top view of FIG. 08 revealing a battery wire clearance slot 1a.

FIG. 09 depicts the locked state of the invention.

FIG. 10 depicts the unlocked state of the invention.

FIG. 11 is a side view of hinged left element 7.

FIG. 11A is a front view of hinged left element 7.

FIG. 11B is a top view of hinged left element 7.

FIG. 12 is a side view of hinged right element 6.

FIG. 12A is a frontal view of hinged right element 6.

FIG. 12B is a top view of hinged right element 6.

FIG. 13 is a partially exploded view of the electronics enclosure.

FIG. 13A is an assembled view of the electronics enclosure.

FIG. 13B is a cutaway view of the electronics enclosure depicting how a motorized servo is mounted.

FIG. 14 is a top view of keyless battery powered locking container cap cover 100 of FIG. 01.

FIG. 15 is a bottom view of a keyless battery powered locking container cap cover lacking the bottom covers.

FIG. 16 is a cutaway sectional top view of the electronics enclosure fitted into closed hinged right element 6 and closed hinged left element 7.

FIG. 17 depicts a lever operated container cap.

FIG. 18 depicts clearance slot in a vertical sidewall of hinged right element 6.

FIG. 19 is a side view detailing peripheral rib 6b.

FIG. 20 is a cutaway view of a custom adapter inserted into hinged right element 6.

FIG. 21 is a cutaway view of a container cap 20d inserted into attachment adapter 20b.

FIG. 21A is a top view of container cap 20d inserted into a custom attachment adapter 20a.

FIG. 22 is an isometric view of universal attachment adapter 20a.

FIG. 23 is a bottom view of the invention depicting breakaway tabs whereby different containers may be protected.

FIG. 24 is a view of the invention depicting hinged left 7 element opened and apart from the hinged right element 6 where the electronic housing remains attached to hinged right element 6.

FIG. 25 is a cutaway view of lid 1 of FIG. 08.

### DETAILED DESCRIPTION OF THE DRAWINGS

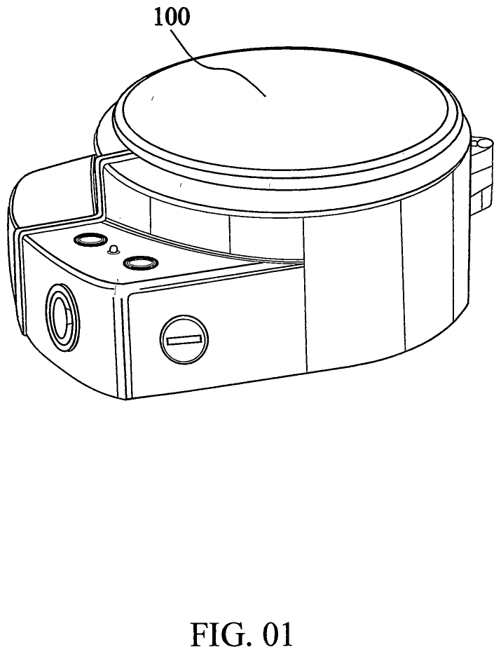

FIG. 01 is a perspective view of keyless battery powered locking container cap cover 100.

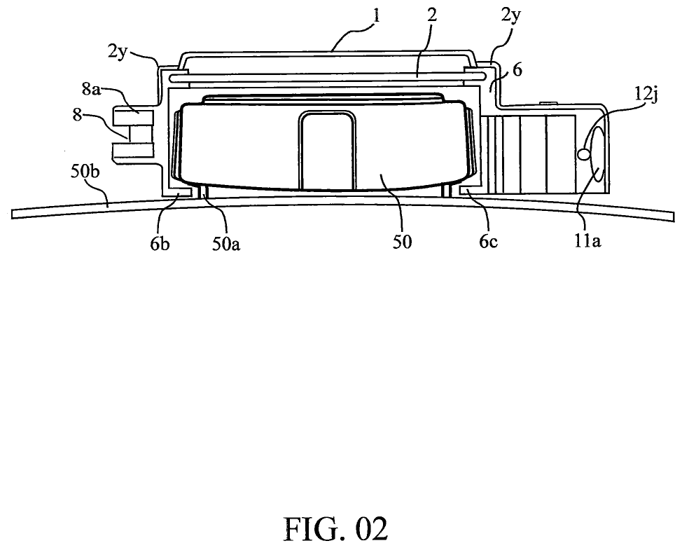

FIG. 02 is a cutaway side view depicting cap 50, filler tube 50a and container top 50b where right element 6 surrounds and encapsulates cap 50; 8a is an element of a hinge 8; 11a is button mounting hole for unlatching button 11; cylinder magnets 12j are configured to repel each other thereby spreading apart right hinged element 6 from left hinged element 7 when unlatched and unlocked; cap 100 where overlapping seam hiding bezel 2y helps to prevent prying.

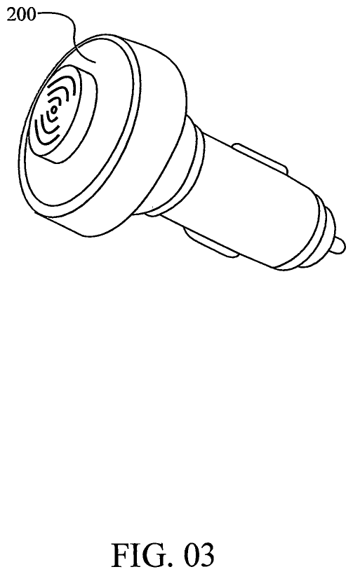

FIG. 03 is a perspective view of RF transmitter 200 configured as a cigarette lighter plug constructed in accordance with the teachings of the present invention where activation of the transmitter bypasses the locking function.

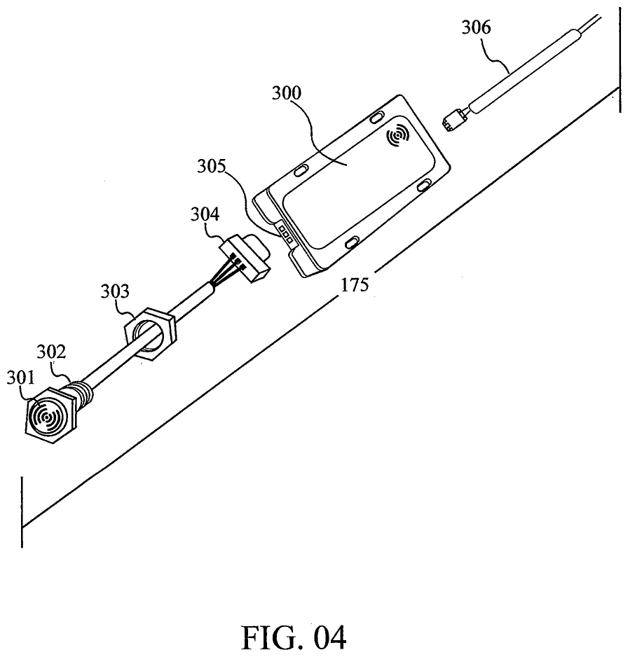

FIG. 04 is an exploded view of a bypass signal RF Transmitter configured to be panel mounted or dash mounted where 301 is the transmitter switch; 302 is the threaded portion that goes through a dash panel; 303 is the nut that sandwiches the panel; 304 is a connector; 305 receives connector 304 and 306 are hookup wires whereby activating the transmitter bypasses the locking function.

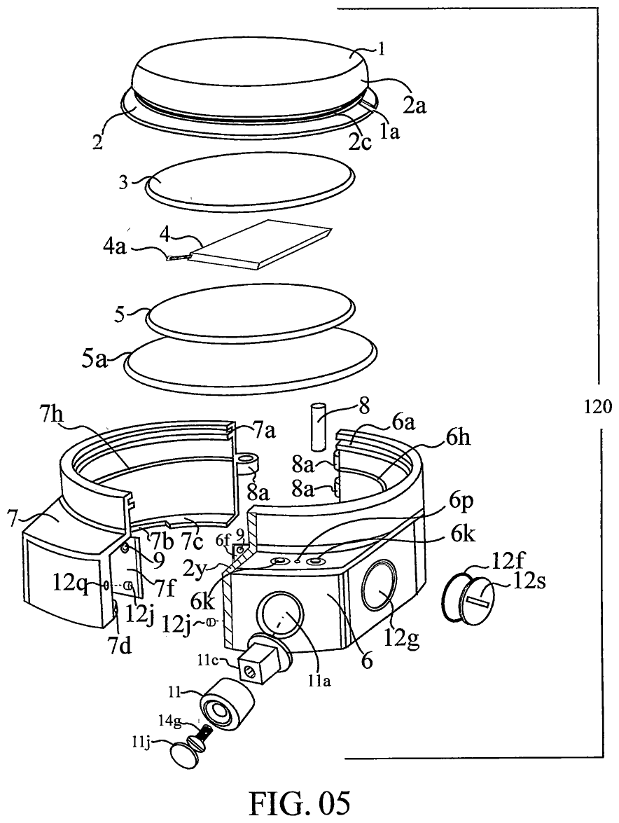

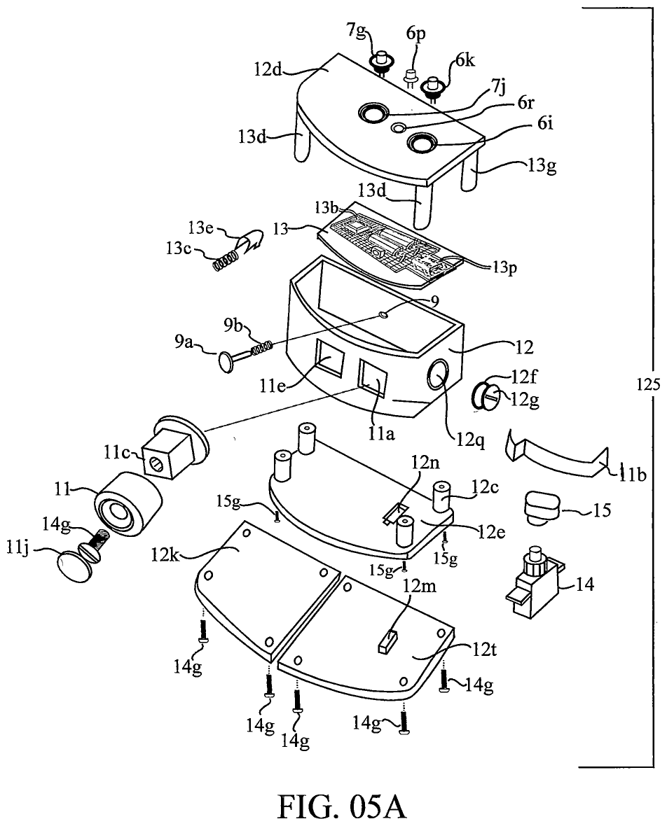

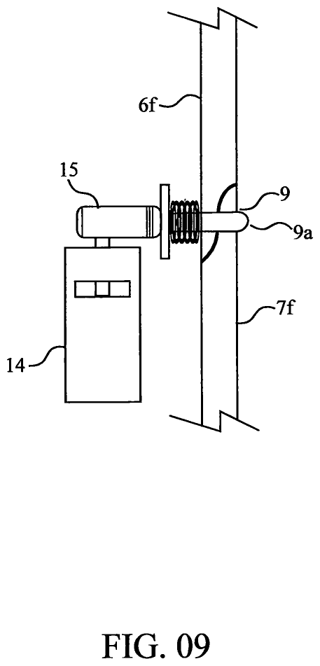

FIG. 05 comprises the first page of a two-page exploded view of the elements of a battery powered keyless locking container cap cover 100 of FIG. 01 as depicted within bracket 120 constructed in accordance with the teachings of the present invention where 1 is a lid; 2 is ledge about the entire circumference of lid 1; 2y is an overlapping seam hiding bezel to prevent prying depicted with slashed lines; 2c is a moisture sealing o ring; 3 is a top thermal foam battery insulator; 4 is a 3.7 volt dc Lithium Ion type battery; 4a is the battery hook up wire; 5 is the bottom thermal Styrofoam battery insulator; 5a is fire rated peel and stick panel sandwiching the battery and top and bottom Styrofoam panels between the underside of lid 1 and peel and stick fire rated panel 5a; 6 is hinged right element partially surrounding lid 1; 6p is an LED indicating a low battery when flashing and further flashes when latch release button 11 is depressed; 7g and 6k are code pin entry switches; 6a is a is an female channel configured to surround ledge 2 of lid 1 where 7a is likewise a female channel; 11 is an unlatching button that must always be activated after activation of the a transmitter and prior to pressing unlatching button 11 in order to bypass the locking function of the invention; 2a is a female channel to receive ledge 2 of lid 1; 12g is a USB-C access hole; 12s is a round threaded coin slot cover that receives o ring 12f and screws into threaded hole 12g of hinged right element 6; 7 is the hinged left element that mates with hinged right element 6 when closed thereby fully encompassing ledge 2 of lid 1; 7h is a peripheral rib of hinged let element 7 that further traps an attachment adaptor between the bottom of peripheral rib 7h and top side of bottom shelf 7b; open areas 6c and 7c not shown of both hinged right element 6 and hinged left element 7 of the invention comprise vent areas providing pressure relief; 8 is a hinge pin; 8acomprises elements of a hinge; 9 is a lock pin hole of ledge 7f of hinged left element 7 where ledge 6f of hinged right element 6 is used to lock the hinged right element and the hinged left element together when the hinged left element and hinged right elements are closed around a container cap; (SEE FIG. 09); 9a is a compression spring loaded lock pin of FIG. 09; 9b is a compression spring of FIG. 09 configured to lock together hinged left element and hinged right elements; 7f is hinged left element 7 lock pin ledge comprising hole 9; when a transmitter is activated, a locking bypass signal is sent that blocks the locking function allowing the flat metal latching spring 11b to release without the secondary locking method being activated thereby allowing an authorized user to remove the invention from a container cap; 11 is an unlatching button activating hidden lock switch 13b that is configured to activate a locking function when depressed by an unauthorized user where lock pin 9a is driven into hole 9 thereby coupling ledge 6f of hinged right element 6 with ledge 7f of hinged left element 7 instantly locking the invention; 11a of element 6 comprises unlatching button 11 mounting hole; 11b is a flat metal latching spring preventing prying apart hinged left element 7 from hinged right element 6 when the invention is closed around a container cap; when the invention is fully closed and all power is off flat metal latching spring 11b is configured to constantly latch over post 7d of left element 7 thereby serving as a primary mechanical latch.

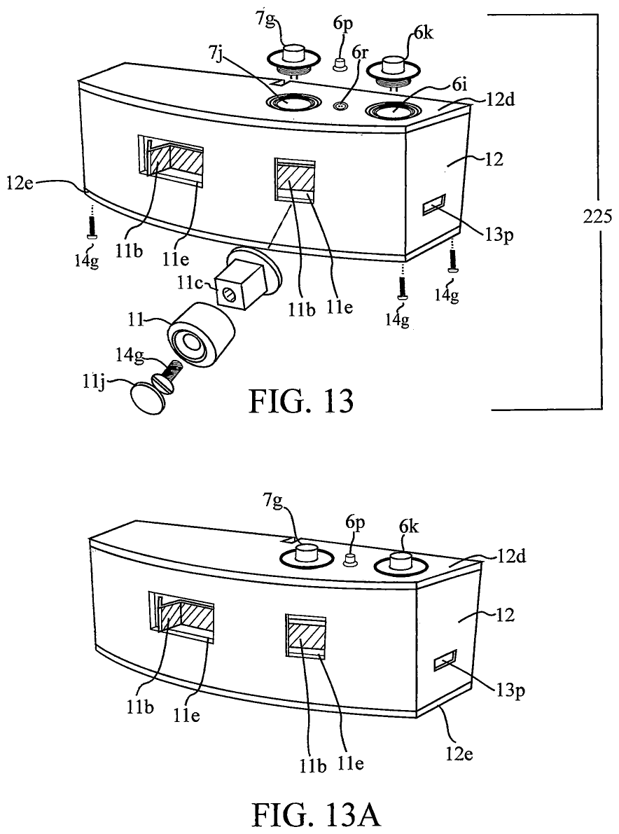

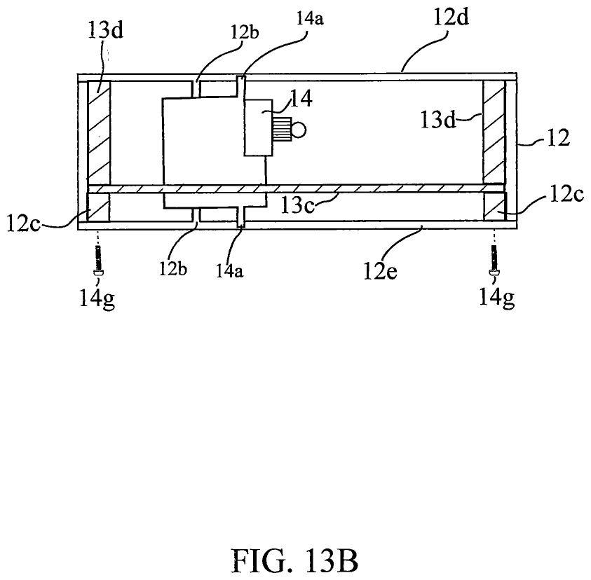

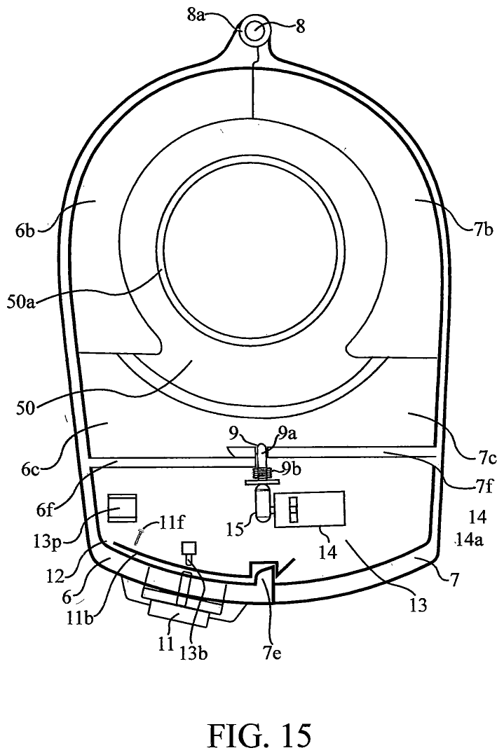

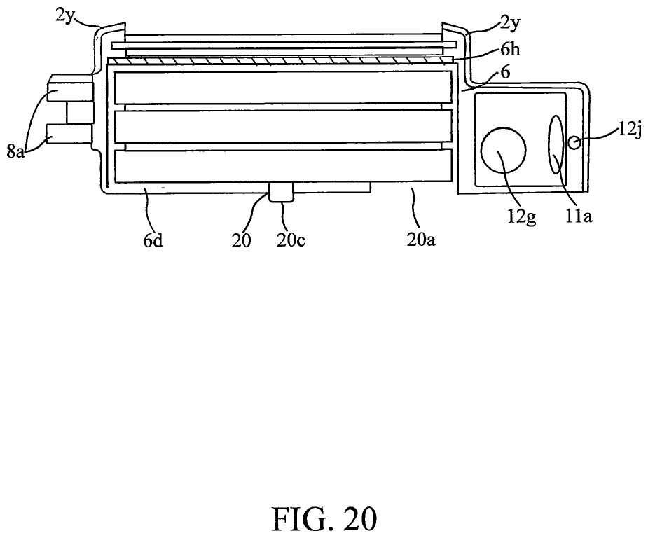

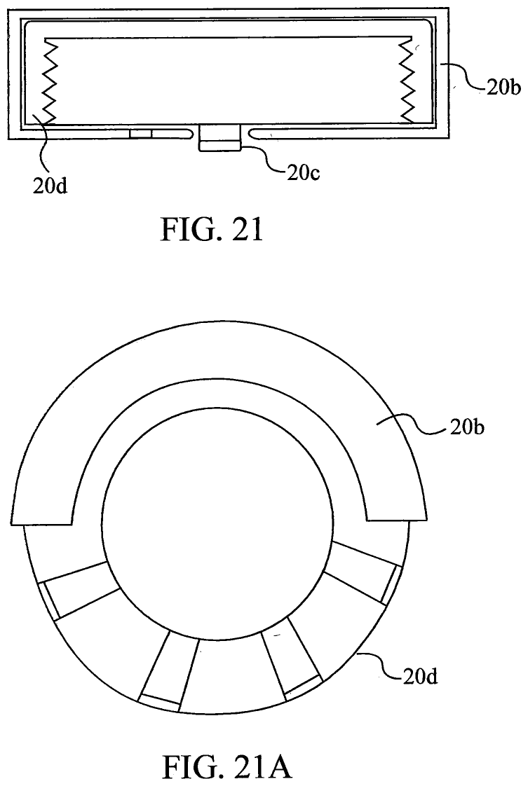

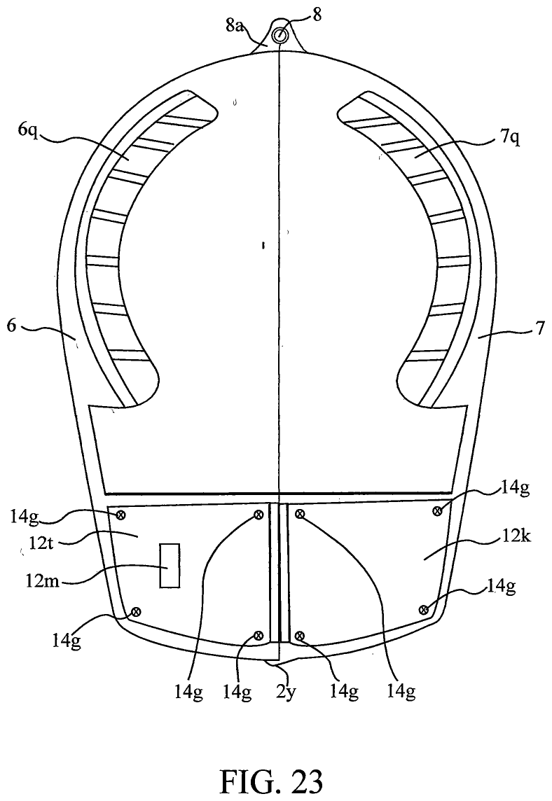

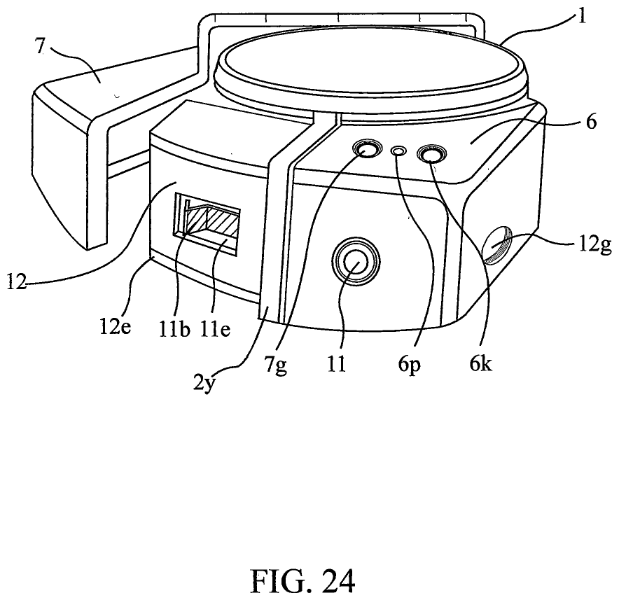

FIG. 05A depicts the second page of a two page exploded view where 12d is the top lid of electronic enclosure of FIG. 13A; 12c are the 4 lower mounting post that sandwich printed circuit board 13; 15 is an offset cam driving lock pin 9a into locked position when activated by hidden lock switch 13b where dc motorized unit 14 rotates offset cam 15 instantly stopping rotation of cam when offset cam lobe 15 has fully driven lock pin 9a through hole 9 of ledges 6f of hinged right element and 7f of hinged left element 5 of FIG. 9 thereby supplying a secondary locking method; 12g is a charging port hole; 13p is a USB type C charging connector; 12e is a bottom cover; 12j are cylinder magnets permanently affixed into hinged right and hinged left elements holes 7m comprising like charged cylinder magnets 12j and 12k correspondingly affixed configured to repel each other and act as a spring separating the hinged right element from the hinged left element when the invention is unlocked for easier removal; 7h is the peripheral rib of hinged left element 7 configured to trap an attachment adapter between top of bottom shelf 7b of hinged left element 7 while peripheral rib 6h of hinged right element 6 is also configured to trap an attachment adapter between the top of the bottom shelf 6b and bottom of peripheral rib 6h as in FIG. 20, FIG. 21, and FIG. 21A; 13g are 4 top mounting posts; 6p is an LED; 6r is an LED placement hole; 6i is a momentary pin code entry switch mounting hole where 7j is a second momentary pin code entry switch placement hole; 13c is a time delay compression spring used to slow the unlatching of flat metal latching spring 11b from latch post 7d of FIG. 15 thereby giving the invention more time to lock itself; 13e is the housing for compression spring 13c; 11 is an unlatching button that must be depressed following activation of the transmitter; to prevent locking; activating either transmitter of FIG. 03 or FIG. 04 bypasses the locking function of the invention; 13 is a printed circuit board comprising the electrical components of the invention; 14 is a motorized unit that rotates offset cam 15; 12 are the outer raised walls of the electronics enclosure of FIG. 13; 11a is a hole to receive unlatching button 11; 11e is a relief hole for flat metal latching spring 11b of FIG. 23; 12p is USB Type C charging port access hole; 13p is a USB-C charging port; 12n is a hole to receive raised area 12m of right bottom cover 12t where 12k is the left bottom cover; raised area 12m of bottom cover 12t mates into female area 12n of electronics enclosure bottom cover 12e thereby permanently attaching electronics enclosure of FIG. 13 to hinged right element 6 while rotating the invention to an open and removable position (see FIG. 24); 14g are eight bottom cover mounting screws; where 15g are the four mounting screws.

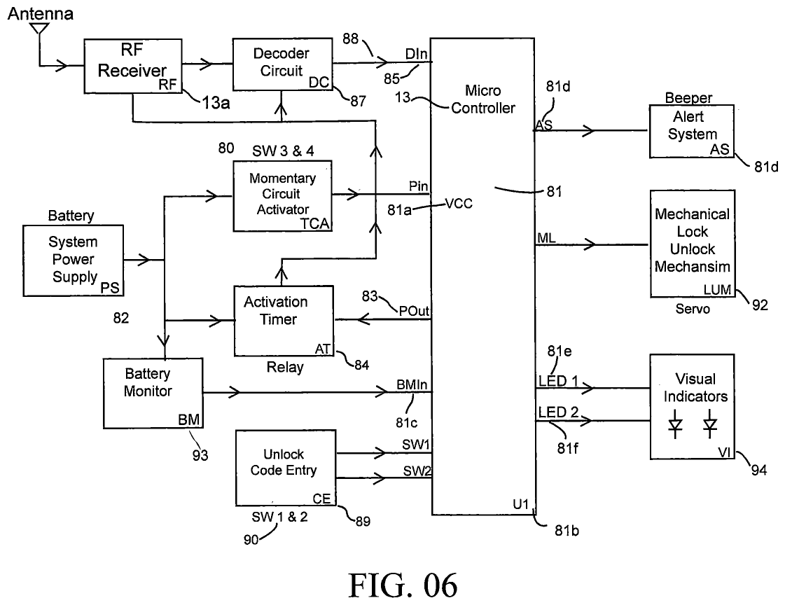

FIG. 06 is a block diagram of the electronic circuitry consisting of all functions described in the Theory of Operations below:

All electrical components are off the shelf.

### Theory of Operation Lock-Unlock Electrical Mechanism

The writers of this patent document hope that they have written an expository patent essay particularly the description of the drawings along with the detailed description of the drawings about the electronic circuitry. Anyone skilled in the art knows that the electronic circuitry, the components or the order in which they are presented may be manipulated or changed but such changes are implicit but not novel nor original and only a way to try to defeat the already patented circuity of U.S. Pat. No. 10,940,984 that is used herein and is the personal property of the writers of this disclosure. Moreover, the present embodiment describes two Pin-code entry switches where other embodiments can utilize many more.

### Refer to FIG. 06

When either of the Momentary Circuit Activator switches 80, SW3 or SW4 is manually closed by the user power is momentarily supplied to the microcontroller 81 at VCC Pin 81a from the System Power Supply PS 82.

The microcontroller program then outputs a signal at Pout 83 to the Activation Timer Relay AT 84 bypassing both manual switches SW3 and SW4 80 and applying power 82 to the microcontroller 81 continuously.

The system program can now continue since it has a steady supply of power from the battery PS 82.

The micro controller program then looks at the input signal at DIN 85 of the microcontroller.

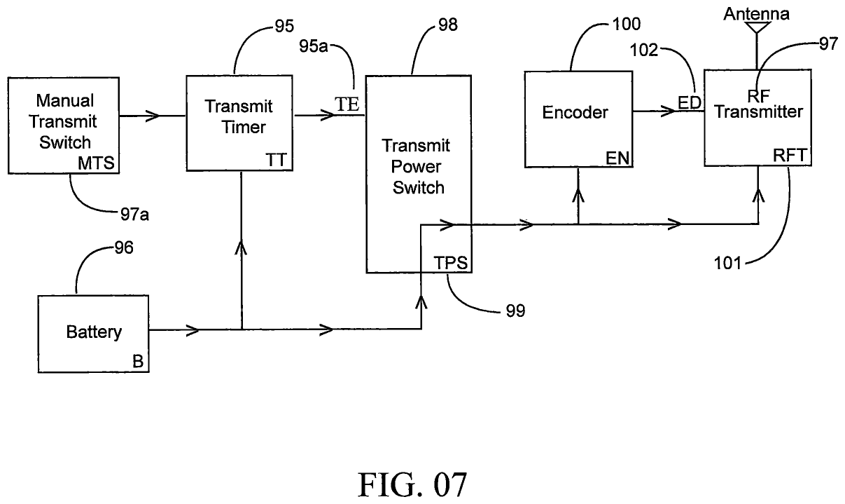

If the remote transmitter 95 FIG. 07 is ON then the RF Receiver RF 86 outputs an encoded signal to the Decoder circuit DC 87.

The decoded signal from the Decoder circuit DC 87 is then applied to Din 88 on the Microcontroller 81.

If the microcontroller U1 81b sees a valid decoded signal at Din 88, then the program continues.

The microcontroller then looks for an unlock code from the unlock code entry CE 89 entered manually by the user via the input pins to the microcontroller at SW1 and SW2 90.

If the microcontroller 81 sees both a valid signal at Din 88 and a recognized unlock code at inputs SW1 and SW2 90, the program continues and outputs a signal ML 91 to the Mechanical Lock/Unlock Mechanism LUM 92.

The system is now unlocked so the user can remove the cap 5 from the filler neck on the storage containers 5y or 5x FIG. 01 and FIG. 02.

If both the above conditions are NOT met then the microcontroller U1 81b does NOT unlock the device.

The state of the battery its charge is monitored when the microcontroller 81 is active via the battery Monitor circuit BM93 via input pin to the microcontroller BMIn 81c.

If the battery is weak, the microcontroller 81 can output a signal to either the AS 81d output line of the microcontroller 81 which activates the alert system AS 81d, a beeper or it can output a signal on either of the microcontroller outputs LED 1 81e or LED 2 81f lighting one or both of the visual indicators V1 94.

FIG. 07 is a block diagram of the electronic transmitting circuitry as described on next page.

### Transmitter Circuit Theory of Operation

### Refer to FIG. 07

Power is applied to the Transmit Timer TT 95 at all times by Battery B1 96

Upon pressing the Manual Transmit Switch MTS 97 the transmit timer is activated.

The Transmit timer TT 95 determines the length of time the system will transmit a fixed code.

When Transmit Timer TT 95 is activated it applies an output signal TE 98 to the Transmit Power Switch TPS 97.

When the Transmit Power Switch TPS 99 is turned ON, power is applied to both the Encoder circuit EN 100 and the RF Transmitter RFT 101

The encoded OUTPUT signal ED 102 from the encoder is transmitted via an RF Transmitter circuit RFT.

This signal is received by the main unit some distance away.

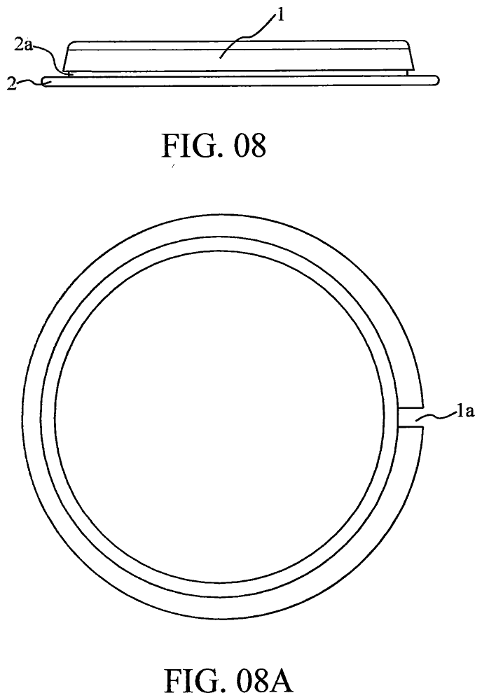

FIG. 08 is a side view of lid 1 depicting seam hiding groove 2a, and ledge 2.

FIG. 08A is a top view of battery wire clearance slot 1a for battery wire 4a of FIG. 05.

FIG. 09 depicts the secondary locked state of the invention rotated to a closed position depicting DC motorized unit 14 where compression spring 9b is compressed by motorized rotation of offset cam 15 thereby driving lock pin 9a into engagement with lock pin holes 9 of ledge 6f of hinged right element and ledge 7f of hinged left element 7 of FIG. 05; when lock pin 9a is in engagement into hole 9 of hinged right element 6 and hole 9 of hinged left element 7, the invention is locked; when lock pin 9a is not into engagement into lock pin hole 9 of hinged left element 7 the invention is unlocked and the locking of the keyless battery powered locking container cap cover can be removed thereby permitting access the existing container cap.

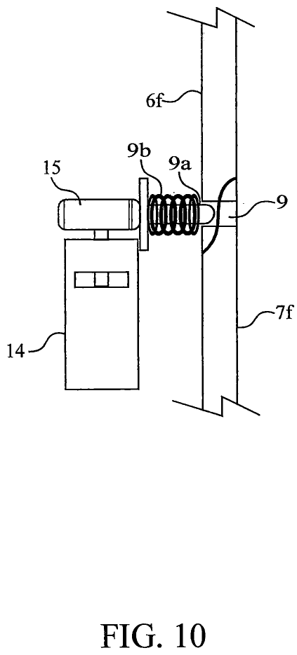

FIG. 10 depicts the secondary unlocked state of the invention whereby the invention is rotated to a closed position but motorized cam 15 has not driven lock pin 9a into hole 9 of hinged left element 7 whereby the hinged right element 6 may be rotated apart from hinged left element 7 of FIG. 05 thereby permitting removal of the keyless battery locking container cap cover.

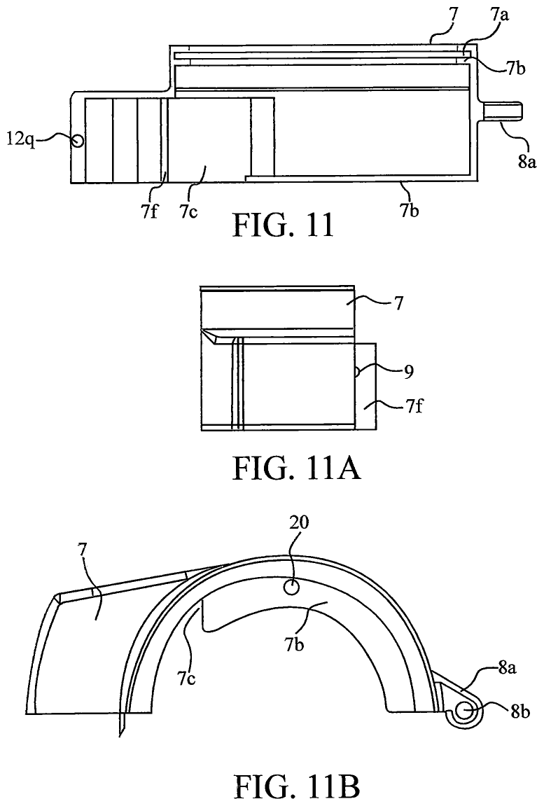

FIG. 11 is a side view of hinged left element 7 further detailing perimeter groove 7a that is configured to house ledge 2 of lid 1; further configured with bottom shelf 7b; further configured with pressure relief opening 7c; further configured with hinge 8a; where 7f is the lock pin ledge and 12q is a hole to receive cylinder magnet 12j.

FIG. 11A is a front view of hinged left element 7 depicting lock pin hole 9 on ledge 7f.

FIG. 11B is a top view of hinged left element 7, where 7b is the bottom shelf, 7c is the vent or pressure relief opening of the bottom shelf; 20 is a hole to receive latch post 20c of custom attachment adapter 20a and 8b is a hinge pin hole.

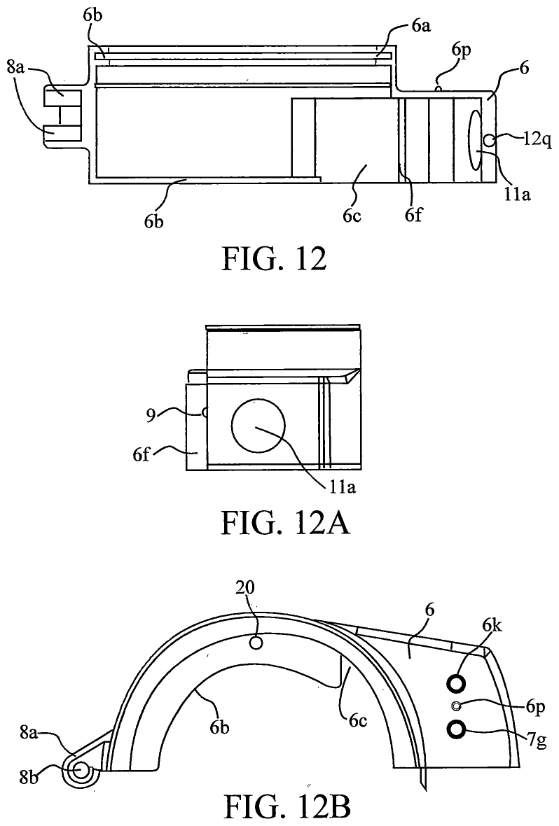

FIG. 12 is a side view of hinged right element 6 where perimeter channel 6a is configured to house ledge 2 of lid 1 of FIG. 05 further configured so that ledge 6f interference fits against ledge 7f of hinged left element 7 where 6p is an led and 8 is part of the hinge; 12q is a hole to accept cylinder magnet 12j positioned opposite cylinder magnet 12j configured with opposing like charges so that the like charges repel hinged left element 7 from hinged right element 6; further configured with bottom shelf 6b and pressure relief opening 6c where 11a is a hole to receive unlatching button 11.

FIG. 12A is a frontal view of hinged right element 6 depicting lock pin ledge 6f, lock pin hole 9 and unlatching button hole 11a.

FIG. 12B is a top view of hinged right element 6 where 20 is a hole to receive latch post 20 of custom attachment adapter 20; 8a is the hinge pin area, 6i is a placement hole for a momentary pin code entry switch; 6k is momentary pin code entry switch; 6p is a led; 7g is a second momentary pin code entry switch; although there are only two momentary pin code entry switches depicted herein, it could be as many as 10 momentary pin code entry switches; 6b is the bottom shelf, 6c is a pressure relief area; 11a is a hole configured to accept unlatching button 11 of FIG. 05.

FIG. 13 is a partially exploded isometric view of the electronics enclosure within bracket 225 detailing lid 12d further depicting placement of the exterior components where 6k is a momentary pin code entry switch; 6i is a hole to mount momentary switch 6k; 6p is an led, 6r is an led mounting hole; 7g is another momentary pin code entering switch; 7j is a mounting hole for momentary pin code switch 7g; 11e of vertical raised wall 12 is configured to receive and mount unlatching button 11; note 11c, the rear part of unlatching button 11 is mounted behind vertical raised wall 12 and sits in front of flat metal latching spring 11b depicted by diagonal lines and when fastened together by screws 14g then covered by glamour cap 11j where top lid 12d and bottom lid 12e sandwich vertical raised wall 12; 11c and unlatching button 11 are elements of unlatching button 11 while 13p is a USB-C charging port further revealing flat metal latching spring 11b positioned behind and adjacent to vertical wall 12; flat metal latching spring 11b continues and protrudes from relief hole 11e; where 12e is the bottom lid.

FIG. 13A is an assembled view of electronics enclosure of FIG. 13 where 12d is the top lid; 12 is the surrounding raised wall; 12e is the bottom lid; 6k is a momentary pin code entry switch; 6p is a led; 7g is also a momentary pin code entry switch; 13p is a USB-C charging port; where flat metal latching spring 11b is positioned behind surrounding riser wall 12 and protruding there from at relief hole 11e.

FIG. 13B is a cutaway front view of electronics housing 13a where 12d is the top lid, 12e is the bottom lid; 12c are bottom post, 13d are top post sandwiching printed circuit board 13c depicting motorized device 14 or in this case, a servo mounting method where servo mounting arms 14a are captured by top lid 12d and lower lid 12e of electronics housing 13a positioned to fit snuggly within grooves 14a of top lid further supported by support ribs 12b, 12d and bottom lid 12e where servo 14 is held firmly while positioned through a hole in printed circuit board 13c.

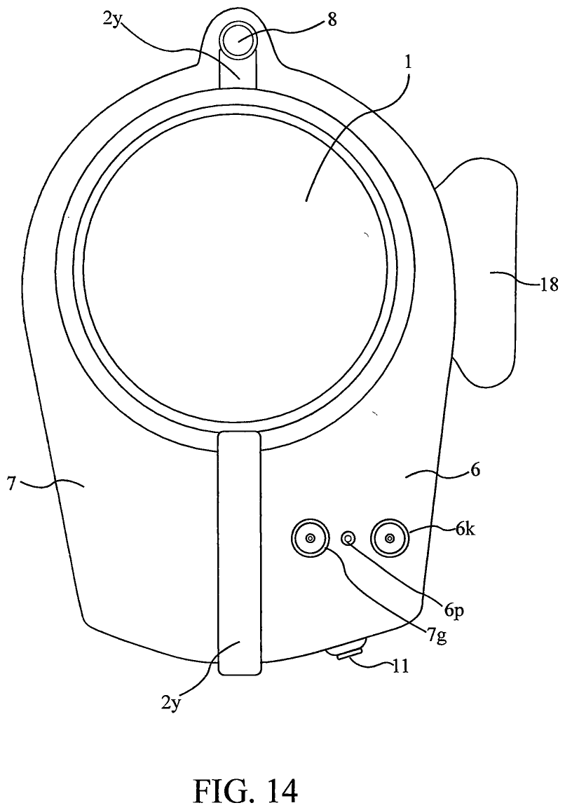

FIG. 14 is a top view of the keyless battery powered locking container cap cover 100 of FIG. 01 rotated to a closed and latched position around container cap 50 of FIG. 02 detailing the 4 steps of entering the numerical pin code: 4332
Step 1. Depress and activate remote operated transmitter button then go to the keyless locking container cap cover 100 and slightly depress unlatching button 11, the led will light signaling power is on.
Step 2. Depress button of momentary pin code entry switch 6k 4 times; to make 4.
Step 3. Depress button of momentary pin code entry switch 7g 3 times to make 3.
Step 4. Depress button of momentary pin code entry switch 6k 3 times to make 3.
Step 5. Depress button of momentary pin code entry switch 7g 2 times to make 2.

Pin code 4332 is now entered. Next wait about 10 seconds; depress unlatching button 11 of FIG. 13 and FIG. 15 very firmly, at least 4 millimeters deep; the keyless locking cover will partially spring open thereby allowing removal without locking; be sure button 11 is deeply depressed enough to unlatch primary flat metal latching spring 11b of FIG. 15.

FIG. 15 is an assembled bottom view looking up with the bottom covers removed depicting placement of the electronic housing of FIG. 13A into hinged right element 6 and hinged left element 7 front compartment; when closed about container cap 50 lock pin ledge 6f overlaps lock pin ledge of 7f whereby lock pin holes 9 align to receive lock pin 9a; 8 is a hinge further describing the locking functions of the invention, container cap 50 is shown fully surrounded by hinged right element 6 and hinged left element 7; 13p is a USB-C battery charging port; 13 is a printed circuit board; 12 is a raised wall of the electronics enclosure with bottom covers 12m and 12n of FIG. 23 removed shown inserted into the closed and locked position of the invention where flat metal latching spring 11b latches over latch post 7e not shown of hinged element 7, where unlatching button 11 when only slightly depressed activates hidden lock switch 13b instantly activating DC motorized unit 14 to rotate 90 degrees clockwise whereby offset cam lobe 15 compresses compression spring 9b thereby driving lock pin 9a through lock pin hole 9 of lock pin ledge 6f and into engagement with lock pin hole 9 of ledge 7f of hinged left element 7 and all power is turned off; the invention is now locked; at this juncture ledge 7f of hinged left element 7 is pinned together with hinged right element ledge 6f thereby utilizing the secondary electronic method to lock the invention; thus the invention comprises a dual locking method of locking where flat metal latching spring 11b serves as the primary locking mechanism and thus as a lock also; flat metal latching spring 11b cannot be unlatched from latch post 7e without first activating hidden lock switch 13b whereby DC motorized unit 14 is activated to rotate and initiate the locking function previously described; therefore it is extremely difficult if not impossible to unlatch flat metal latching spring 11b without locking the secondary locking method; R F transmitters of FIG. 03 and FIG. 04 and described in the Theory of Operation when activated send a bypass code that blocks the locking function thereby allowing an authorized person to depress unlatching button 11 deep enough to unlatch flat metal latching spring 11b from latch post 7e without locking the invention thereby permitting removal from existing container cap 50.

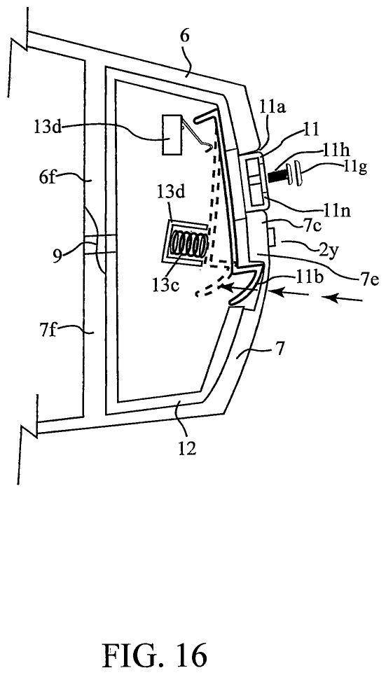

FIG. 16 is a cutaway, sectional top view of the front of the invention where electronics enclosure is housed therein depicting raised vertical wall 12 of the electronics enclosure of FIG. 13a further depicting flat metal latching spring 11b depicted by solid lines when latched where further depicted as unlatched by dashed lines where 6 is hinged right element 6; 7 is hinged right element 7; 13b is hidden lock switch positioned behind flat metal latching spring 11b where, when unlatching button 11 is depressed as depicted by dashed lines hidden lock switch 13b is activated in less than 0.50 seconds; unlatching is achieved by depressing unlatching button 11 at least four millimeters deep thereby unlatching flat metal latching spring 11b; hole 11a receives unlatching button 11; unlatching button 11 must be depressed 4 to 5 mm in order to unlatch flat metal latching spring 11b from latch post 7e; compression spring 13c is configured to further delay the unlatching of flat metal latching spring 11b from hinged left element 7 latch post 7e; 13d is the housing for compression spring 13c; attachment screw 11h is configured to attach and sandwich riser 12 of electronics enclosure of FIG. 13A with unlatching button 11n; 11g is a glamour cap; 2y is a seam hiding bezel where 9 is a lock pin hole depicted by dash lines of ledge 6f of hinged right element and corresponding ledge 7f of hinged left element further configured to line up when the invention is closed around a container cap.

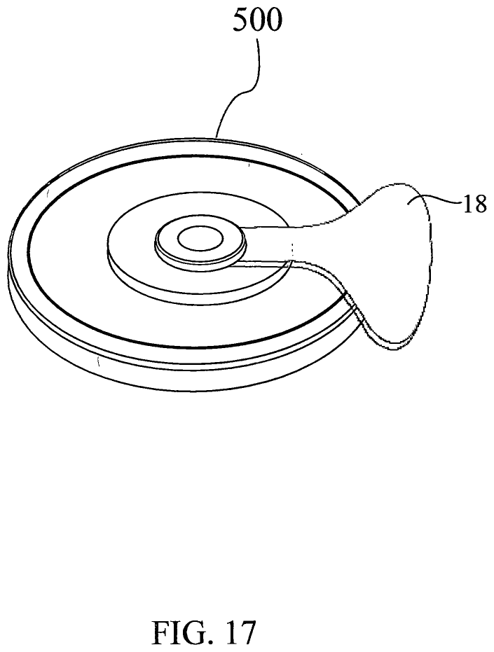

FIG. 17 is a perspective view illustration of lever actuated container cap 500 where 18 represents a lever.

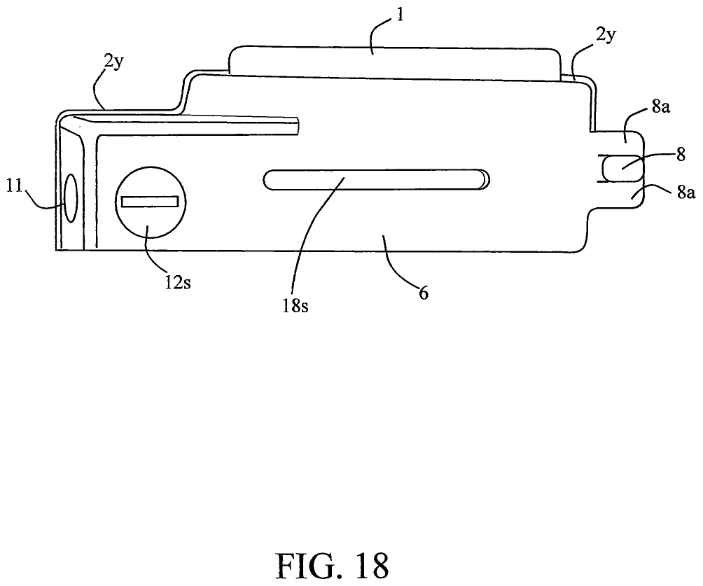

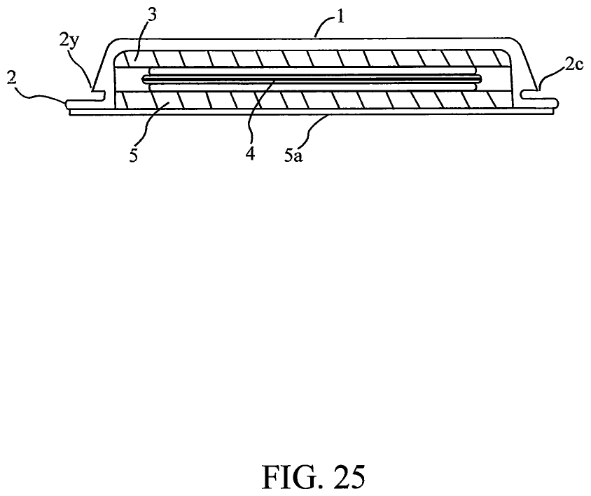

FIG. 18 depicts slot 18s in a perimeter twall of hinged right element 6 configured to provide container caps utilizing a latching lever 18 of FIG. 25 an area or slot whereby said lever 18 may protrude through; 2y is a seam overlapping bezel that prevents prying where the mating seams between hinged right element 6 and hinged left element 7 meet when rotated to a closed and latched position.

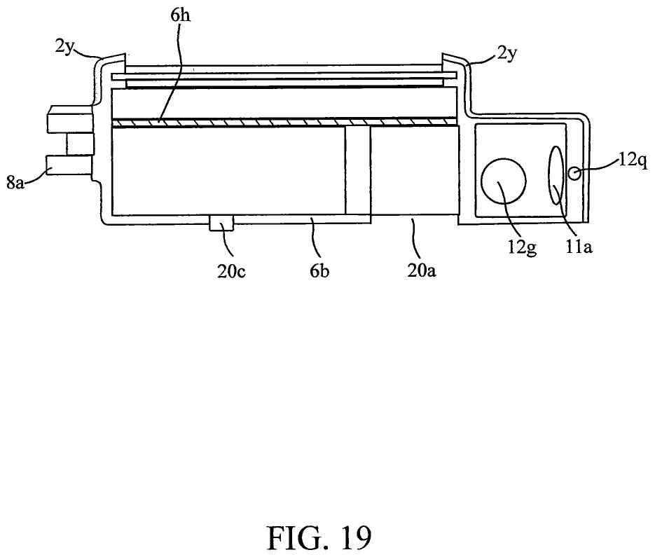

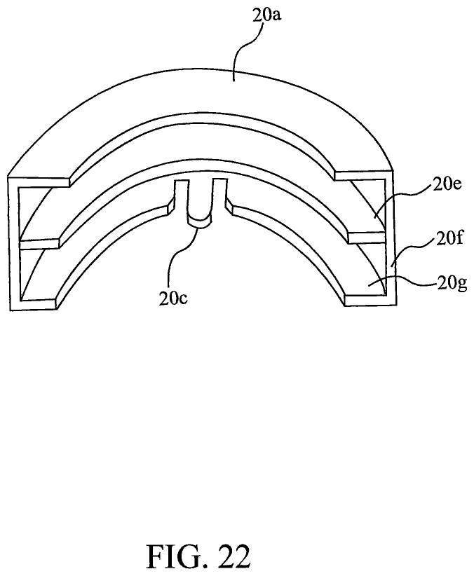

FIG. 19 is a side view of hinged right element 6 depicting peripheral rib 6b configured to maintain a custom attachment adapter between the underside of peripheral rib 6b and the bottom shelf 6d; 2y is an overlapping seam hiding bezel that protects from prying; 7m is a hole to house a magnet 12j; where 11a is a hole to receive 8a is an element of a hinge unlatching button 11; 20 is a latch post mounting hole to receive latch post 20c of FIG. 22 of a custom mounting adapter; and 6c is an open vent area while 8a is an element of a hinge.

FIG. 20 describes peripheral rib 6h indicated by diagonal lines located on the vertical inner walls of hinged right element 6 configured to position and snugly hold custom attachment adapter 20abetween peripheral rib 6h, and bottom shelf 6d where latch post 20c presses and latches into latch hole 20 centered in bottom shelf 6d of either hinged right element 6 or bottom shelf 7d of hinged left element 7; custom attachment adapters are configured as mirror image therefore the same custom attachment adapter will fit into either the hinged right element 6 or hinged left element 7; 8a is part of a hinge.

FIG. 21 further describes a factory container cap 20d partially surrounded by custom attachment adapter 20b configured to encircle one half of a factory container cap 20d when positioned around factory container cap 20d (See FIG. 21A); any number of custom attachment adapters may be designed to fit any factory container cap making the invention universal while retaining a custom fitment over and around a factory container cap 20d.

FIG. 21A is a top view of FIG. 21 and custom attachment adapter 20b is configured to mate with mirror image custom attachment adapter 20b thereby completely encircling container cap 20d.

FIG. 22 is an isometric view of a custom attachment adapter 20b where 20c is the latch post that snaps custom attachment adaptor 20b into latch hole 20 of FIG. 20 further depicting adapter shelf 20e configured to mate around any custom container cap outer diameter; 20f is the outer vertical wall while bottom shelf 20g houses latch post 20c and can be custom configured to mate around the diameter of any size container filler tube.

FIG. 23 is a bottom view of the invention comprises universal breakaway bottom shelf tabs 6q of hinged right element 6 and breakaway shelf tabs 7q of hinged left element 7 configured to break off sections further configuring the bottom shelf diameter to fit different sized diameter container caps thereby where one size fits all container caps in each category of containers, Bottom covers 12k and 12t seal the bottom area and are attached by recessed head screws 14g where bottom cover 12m further comprises raised area 12m that mates with female area 12n of bottom lid 12e of FIG. 23 where 2y is an overlapping seam hiding bezel.

FIG. 24 is a perspective view of keyless battery powered locking container cap cover 100 of FIG. 01 where hinged left element 7 is partially rotated open revealing the electronic enclosure of FIG. 13 separated from hinged left element 7 while remaining attached to hinged right element 6 further revealing lid 1; raised vertical wall 12 of FIG. 13; flat metal latching spring 11b with clearance hole 11e provides a secondary/locking of left element 7 when closed against right element 6 where 11 is an unlatching button; 2y is an overlapping seam cover; 7g is a pin code entry switch mounting hole; 6p is an led; 12g is a USB-C access hole.

FIG. 25 is a cutaway view of lid 1 where thermal battery insulation is provided by sandwiching battery 4 between top and bottom Styrofoam insulating panels 3 and 5 further sandwiched and held in place by 2.5 mil thick fire rated peel and stick PET film 5a.

For the purposes of promoting and understanding the principles disclosed herein, reference is made to the preferred embodiments illustrated in the drawings and specific language was used to describe the same. It will nevertheless be understood that no limitation of the scope is thereby intended. Such alterations and further modifications in the illustrated device and such further applications are the principles disclosed as illustrated herein as being contemplated as would normally occur to one skilled in the art to which this disclosure relates.

1. A keyless battery powered locking container cap cover configured for attachment around a container cap while remaining in an unlocked configuration following attachment comprising: a hinged left element, a hinged right element comprising generally annular structures, further comprising bottom shelves to prevent lifting off, further comprising a lid thereby fully encompassing the container cap that instantly locks during unauthorized removal attempts thereby eliminating theft or contamination of the containers contents or theft or damage to the original container cap.

2. The keyless battery powered locking container cap cover circuitry of claim 1 where all power is immediately turned off and remains turned off following the locking or unlocking of the keyless locking container cap cover around an existing container cap thereby saving battery power.

3. The keyless battery powered locking container cap cover of claim 1. further comprising primary latching and locking methods where the primary latching method comprises a flat metal latching spring, where a secondary locking method comprises a spring mounted locking pin; where a hidden locking switch is configured to activate a motor driven cam; where the cam instantly initiates the locking function; where a servo or otherwise motorized device is configured to drive the spring-loaded mounting pin into or out of a locking position; where the power source provides power to a motor driven cam, servo or other motorized device.

4. The metal latching spring of claim 3 configured to conceal a hidden locking switch configured to activate a motor driven cam thereby instantly initiating the locking function that latches the hinged left element and hinged right element together when rotated to a closed position around a container cap where the metal latching spring is positioned in front of a compression spring that further delays the unlatching of the metal latching spring thereby allowing more time for the latching function.

5. The keyless battery powered locking container cap cover receiver circuitry of claim 1 configured to be on only during locking or unlocking periods and off at all other times.

6. The keyless battery powered locking container cap cover receiver circuitry of claim 1 further comprising an R F transmitter configured to look like a cigarette lighter plug that can be plugged into a power socket or further configured to permanently mount in a dash panel or other select location where it can be hard wired to an ignition switch or any convenient power source so that when activated, the R F transmitter transmits a bypass code that blocks the locking function thereby allowing unlatching, removal or replacement of the keyless battery powered locking container cap cover.

7. The keyless battery powered locking container cap cover of claim 1 where the bottom shelf is configured for removal from a container cap by only partially opening the hinged left and hinged right elements.

8. The keyless battery powered locking container cap cover of claim 1 further configured to allow venting or pressure relief from an open area of the bottom shelfs.

9. The keyless battery powered locking container cap cover of claim 1 configured with overlapping seam covers configured to prevent prying apart the hinged left element from the hinged right element.

10. The keyless battery powered locking container cap cover of claim 1 comprising a separate lid comprising a 360-degree bottom ledge that is captured by female channels in the hinged left end hinged right elements further configured to house an o ring where the inner wall of the female grooves compresses an o ring when the hinged left element and hinged right element are rotated to a closed and latched position thereby providing a water tight seal.

11. The keyless battery powered locking container cap cover lid of claim 17 further configured to house a low-profile battery where fire rated Styrofoam thermally insulating panels are positioned above and below the battery further comprising a peel and stick fire rated polyester adhered to and holding in position the battery components assembly.

12. The keyless battery powered locking container cap cover of claim 1 further comprising a USB charging port thereby enabling recharging.

13. The keyless battery powered locking container cap cover of claim 1 remaining in a locked configuration after attachment.

14. The keyless battery powered locking container cap cover of claim 1 comprising a horizontal peripheral rib on the inner vertical walls of the hinged left element and the hinged right element configured to trap and snugly hold a custom attachment adaptor between the peripheral rib and the bottom shelf where the custom attaching adaptors are configured to adapt the invention to fit different container caps thereby providing a universal device whereby the same device fits multiple applications by only utilizing a custom attaching adaptor.

15. The keyless battery powered locking container cap cover of claim 1 comprising opposing magnets of like charge positioned in the hinged left element and the hinged right element configured to act as a spring and repel the hinged left element from the hinged right element when unlocked thereby spacing apart the hinged left element from the hinged right element providing easier removal.

16. The keyless battery powered locking container cap cover of claim 1 not requiring a Department of Transportation approval.

18. The keyless battery powered locking container cap cover of claim 1 configured with a slot in the right hinged element or a slot in the left hinged element allowing a container cap's lever to protrude therefrom.

19. The keyless battery powered locking container cap cover of claim 1 that will frictionally rotate around a container cap when locked after attachment thereto.

20. The keyless battery powered locking container cap cover of claim 1 that will frictionally rotate around a container cap cover.

21. The keyless battery powered locking container cap cover configured with a slot allowing a container cap that utilizes an attachment seal lever to protrude through.
